(19) United States
(12) Patent Application Publication
(10) Pub. No.: US 2016/0109724 A1
(43) Pub. Date: Apr. 21, 2016

(54) MICROSCOPIC EYEWEAR SYSTEM AND METHOD

(71) Applicant: Boze Anderson, Los Angeles, CA (US)

(72) Inventor: Boze Anderson, Los Angeles, CA (US)

(21) Appl. No.: 14/519,139

(22) Filed: Oct. 21, 2014

(51) Int. Cl. G02C 5/20; G02B 21/00; G02B 7/09; G02B 7/28; G02C 5/14; G02C 5/22; G02B 7/00; G02B 21/02; G02C 11/04

(52) U.S. Cl. CPC G02C 5/20; G02B 21/02; G02B 21/0008; G02B 7/09; G02C 11/04; G02C 5/143; G02C 5/22; G02B 7/003; G02B 7/28

(57) ABSTRACT

A microscopic eyewear system and method. The microscopic eyewear system utilizes at least one lens to magnify the specimen and form an enhanced magnified specimen image. The lens automatically adjusts its distance relative to the specimen by extending and retracting relative to the eyes, such that light from the specimen is captured and focused. An adjustment mechanism, such as a gear worm, extends and retracts the lens. A sensor detects the specimen and focuses the light. A microprocessor operatively connects to the sensor, and controls operation of the adjustment mechanism.

### CLAIM OF PRIORITY

This application claims priority from U.S. Provisional Patent Application No. ______ the entirety of the specification of which is hereby incorporated by reference as if fully set forth in the present specification. [Boze: are we still using the provisional that was recently filed; not sure, since there was little or no content in there?]

### BACKGROUND OF THE INVENTION

The present invention relates generally to microscopic eyewear, and more specifically to a microscopic eyewear systems and methods for enhanced magnification.

Microscopes are instruments used to see nano or micro-sized objects that are too small for the naked eye to see clearly. Microscopes make specimens seem larger than they are, from 10 times larger to about 1000 times larger. The most common microscope is the optical microscope, which uses light to image the sample. The optical microscope has one or more lenses producing an enlarged image of a sample placed in the focal plane. Optical microscopes have refractive glass and occasionally of plastic or quartz, to focus light into the eye or another light detector.

As mentioned above, the lenses can be adjusted to provide the optimal focus and light capturing capacity for magnifying a specimen. Typically, magnification of a light microscope, assuming visible range light, is up to 1250× with a theoretical resolution limit of around 0.250 micrometers or 250 nanometers. This limits the practical magnification limit to ˜1500×. Nonetheless, these lenses require constant manipulations to maximize efficiency and light focusing capacity.

It is within the above context that a need for the present invention has arisen and the present invention meets this need.

### BRIEF SUMMARY OF THE INVENTION

Various aspects of a microscopic eyewear system and method can be found in exemplary embodiments of the present invention.

In a first embodiment, the microscopic eyewear system is worn in front of the eyes to provide portable and hands-free magnification of micro and nano-sized specimens. The microscopic eyewear system utilizes at least one lens, which generally has a very short focal length, to view the specimens through angular magnification. The lens automatically adjusts its distance relative to the specimen, such that light from the specimen is focused, to form an enhanced magnified specimen image.

A sensor on the microscopic eyewear system senses light to detect and focus on the specimen. A microprocessor operatively connects to the sensor to calculate the optimal focal point for magnifying the specimen, and adjusts the lens accordingly. The processor controls a motor, which extends and retracts the lens through an adjustment mechanism. A counterweight helps balance the microscopic eyewear system when it is extended.

The microscopic eyewear system includes at least one lens configured to magnify the view of the micro and nano-sized specimens through angular magnification. The lens may include a single convex lens, or multiple lenses positioned adjacent and parallel to each other. For example, an ocular lens near the eyes and an objective lens more proximal to the specimen. Each lens can either move independently, or remain engaged with the other lenses.

A lens frame secures the lens at a predetermined distance in front of the eyes. The lens frame is adapted to be worn on the face. The lens frame includes a lens slot that receives a peripheral portion of the lens to secure the lens at a desired angle relative to the eyes. The lens frame can have a slight curve at both ends to conform to the shape of curved lens. The lens frame includes an outwardly facing sensor that senses the light to detect and focus on the specimen. A microprocessor in the lens frame operatively connects to the sensor to control the position of the lens.

A pair of arms (temples) is hingedly connected to the ends of the lens frame. The pair of arms are adapted to be hung on the ears to support the lens frame in front of the eyes. The pair of arms includes an inner surface having a grip member for helping to retain the microscopic eyewear system on the ears and along the sides of the head. The pair of arms can pivot laterally to move between an operational position and a storage position.

The pair of arms includes a motor and an adjustment mechanism configured to extend and retract the lens frame relative to the specimen. This adjustability function helps focus the light and move the lens in better viewing position to the specimen to form a magnified specimen image. A counterweight on each arm helps balance the microscopic eyewear system on the ears when the lens frame is fully extended.

A further understanding of the nature and advantages of the present invention herein may be realized by reference to the remaining portions of the specifications and the attached drawings. Further features and advantages of the present invention as well as the structure and operation of various embodiments of the present invention are described in detail below with respect to the accompanying drawings. In the drawings, the same reference numbers indicate identical or functionally similar elements.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A illustrates a block diagram that uses a simple microscopic eyewear system to view a magnified specimen image in accordance with an embodiment of the present invention;

FIG. 1B illustrates a block diagram that uses a simple microscopic eyewear system to view a magnified specimen image in accordance with an embodiment of the present invention;

FIG. 2 shows an isometric view of the microscopic eyewear system, in accordance with an embodiment of the present invention;

FIG. 3 shows a top view of the microscopic eyewear system, in accordance with an embodiment of the present invention;

FIG. 4 shows a sectioned side view of the microscopic eyewear system showing the circuitry, power source, and motor, in accordance with an embodiment of the present invention;

FIGS. 5A and 5B are sectioned side views, the section taken along section 5-5 of FIG. 3, showing an adjustment mechanism, where FIG. 5A shows the adjustment mechanism in a retracted position, and

FIG. 5B shows the adjustment mechanism in an extended position, in accordance with an embodiment of the present invention; and

FIG. 6 shows a flowchart diagram of a method for magnifying a specimen with a microscopic eyewear system, in accordance with an embodiment of the present invention.

Unless otherwise indicated illustrations in the figures are not necessarily drawn to scale.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail so as to not unnecessarily obscure aspects of the present invention.

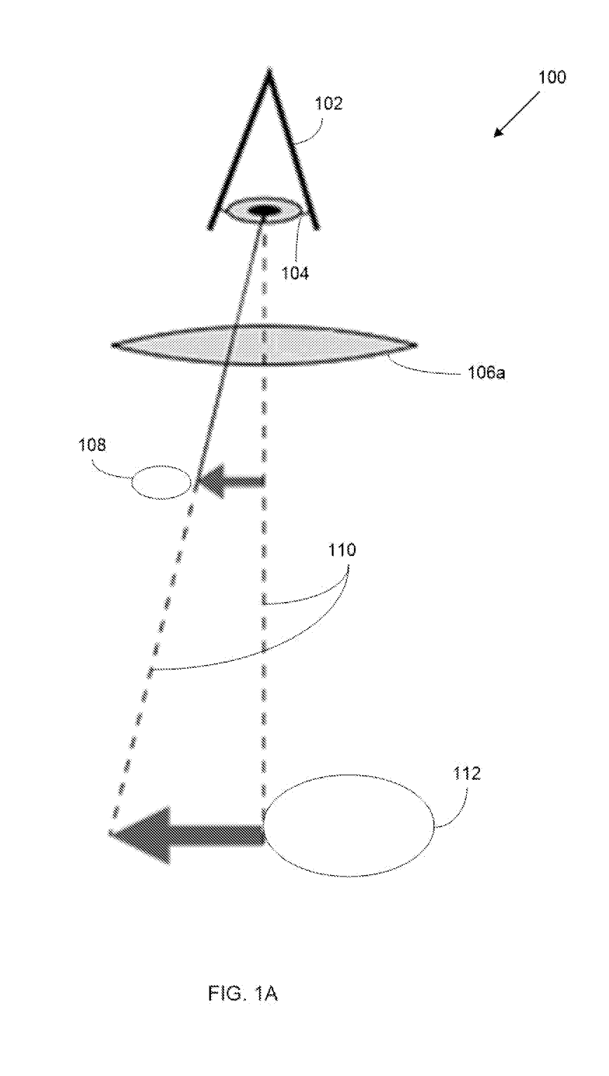

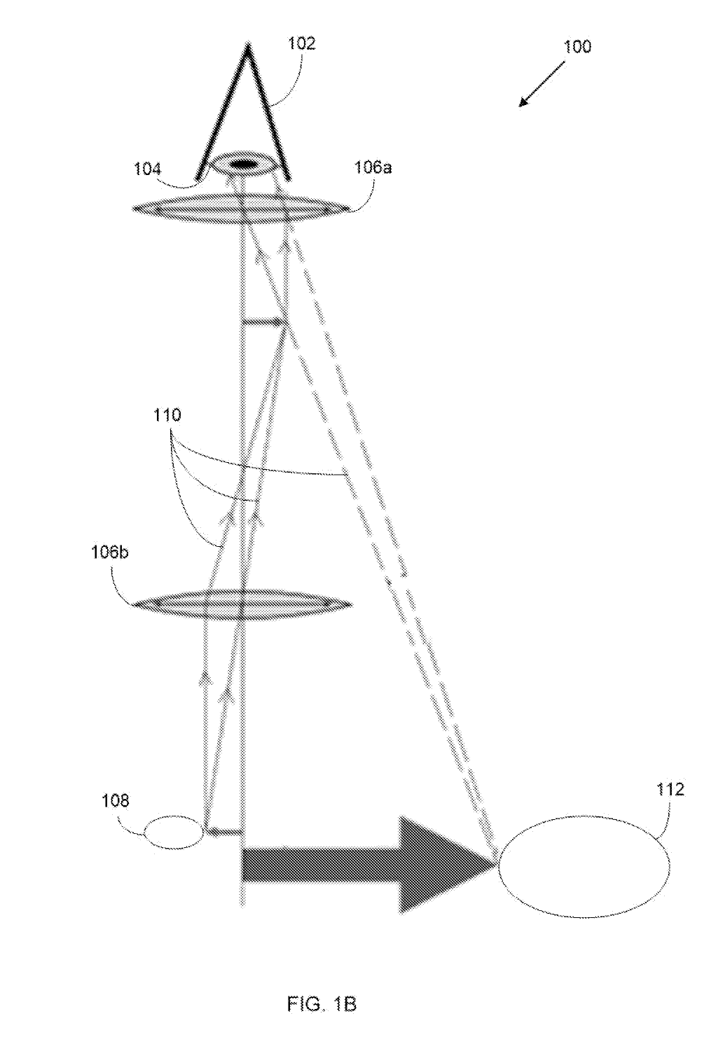

FIGS. 1A and 1B show block diagrams of a simple microscopic eyewear 100 used for viewing a specimen 108 to form a magnified specimen image 112, where FIG. 1A uses a single convex lens 106a, and FIG. 1B uses an ocular and objective lens 106b.

In FIGS. 1A and 1B, the microscopic eyewear 100 is worn in front of the eyes to provide portable and hands-free magnification of micro and nano-sized specimens 108. The microscopic eyewear 100 utilizes at least one lens 106a, which generally has a very short focal length, to view the specimen 108 through angular magnification.

The lens 106a automatically adjusts its distance relative to the specimen 108, such that light 110 from the specimen 108 is focused to form an enhanced magnified specimen image 112. The specimen 108 may be any micro or nano-sized object commonly viewed under a microscope, including, without limitation, cellular matter, bacteria, fungi, mold, insects, organic matter, and sediments.

As referenced in FIG. 1A, the lens 106a can be a single convex lens that magnifies the specimen 108 through angular magnification alone, providing an erect enlarged virtual specimen image 112. In one embodiment, the single convex lens can magnify the specimen 108 up to 10×.

Those skilled in the art will recognize that, in general, microscope optics are static. To focus at different focal depths, the distance between the lens 106a and the specimen 108 is adjusted. However, to obtain a wider or narrower field of view, multiple lenses 106a, 106b may be used. The present invention is efficacious in automatically adjusting the distance between the lens 106a and the specimen 108 to arrive at the optimal magnified specimen image 112.

Turning now to FIG. 1B, the at least one lens 106a can be an ocular lens proximal to the eyes, and 106b may be at least one objective lens proximal to the specimen 108. The least one objective lens may move relative to the leans 106a for enhancing the magnification. For example, the ocular lens remains close to the eye, and the at least one objective lens extends towards the specimen 108. Though in other embodiments, the lenses 106a, 106b can remain engaged (not shown) to each other, relying on different thicknesses and curvature to complement each other for enhancing the magnification.

For example, the at least one objective lens positions proximally to the specimen 108 to collect and focus light 110, to view the magnified specimen image 112 of the specimen 108. The magnified specimen image 112 is then further magnified by the ocular lens, which lies close to the eye. Those skilled in the art will recognize that the use of both the ocular lens and the at least one objective lens working together allows for much higher magnification, reduced chromatic aberration, and enhanced resolution contrast. Also, advanced illumination setups, such as phase contrast are possible with multiple lenses 106a, 106b.

Since the at least one lens 106a is worn in front of the eyes, like a pair of glasses; the at least one lens 106a can also be positioned laterally, vertically, and horizontally relative to the specimen 108 by simply moving the head to a desired position.

Additionally, the specimen 108 can be set on a stable surface or held in a hand. In this manner, the microscopic eyewear 100 provides greater flexibility for magnifying functions. Suitable uses for the microscopic eyewear 100 may include without limitation: field operations where a stable laboratory is not available; classroom settings where individual microscopes for each student is cost prohibitive; and traveling scientific expeditions where a regular microscope is too large and heavy for transport.

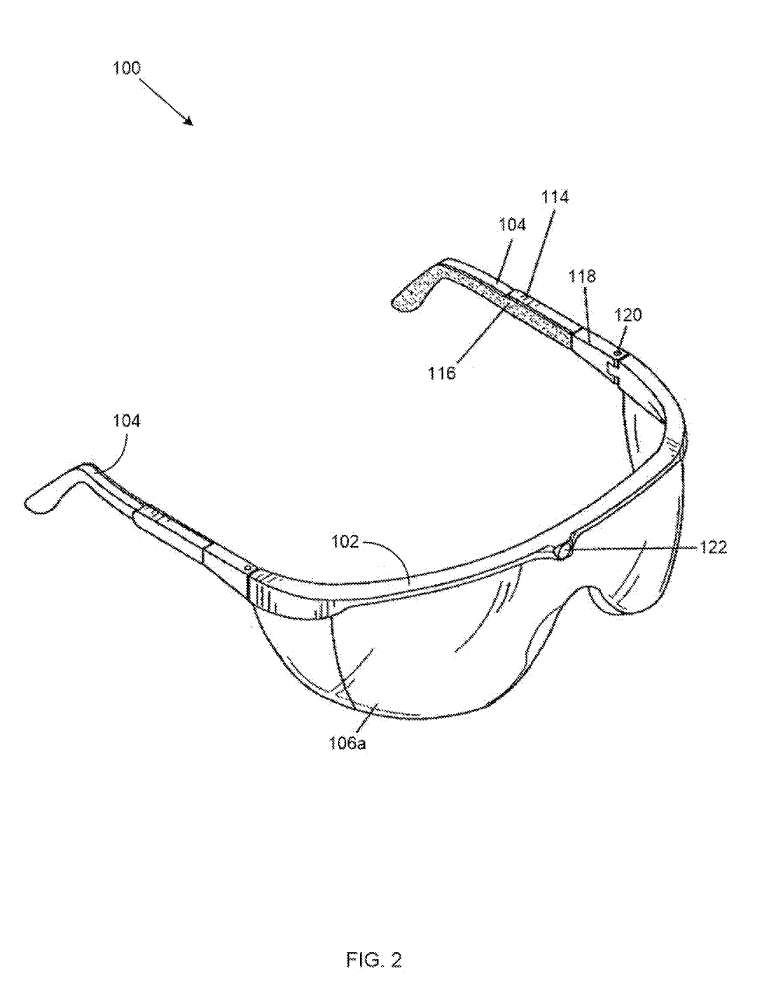

FIG. 2 shows an isometric view of the microscopic eyewear 100, in accordance with an embodiment of the present invention.

FIG. 2 shows at least one lens 106a on the microscopic eyewear 100. The at least one lens 106a is configured to magnify the view of the micro and nano-sized specimens 108 through angular magnification. In some embodiments, the lens 106a may magnify the specimen 108 at 10X, 20X, 40X, and 100X.

But generally, the lens 106a makes the specimen 108 appear from multiple times larger. The type and number of lenses 106a, 106b are determinative of the quality of the magnification. Suitable materials for the lens 106a may include, without limitation, refractive glass, quarts, and plastic.

The lens 106a may include a single convex lens, or multiple lenses 106a, 106b positioned adjacent and parallel to each other. In the multiple lens 106a, 106b configuration, an ocular lens positions near the eyes, and an objective lens positions more proximal to the specimen 108. Each lens 106a can either move independently, or remain engaged with the other lens 106b.

In one embodiment, the objective lens generally moves by extending and retracting relative to the ocular lens and the specimen 108 to focus and gather light 110 more effectively. The ocular lens magnifies the magnified specimen image 112 captured by the objective lens.

A lens frame 102 secures the lens 106a at a predetermined distance in front of the eyes, generally resting across the forehead. The lens frame 102 attaches the at least one lens 106a in front of the face. The lens frame 102 includes a slot that receives a peripheral portion of the lens 106a to secure the lens 106a at a desired angle relative to the eyes.

The lens frame 102 can have a slight curve at both ends to conform to the shape of a curved lens. Suitable materials for the lens frame 102 may include, without limitation, a polymer, polyvinyl chloride, polyurethane, polyethylene, aluminum, fiberglass, rubber, and wood.

A sensor 122 on the lens frame 102 senses the light 110 on the specimen 108. In this manner, the specimen 108 is detected and the light 110 that is transmitted through the specimen 108 is focused to create the magnified specimen image 112.

A microprocessor 130 in the lens frame 102 operatively connects to the sensor 122 to control the position of the lens 106a. The microprocessor 130 calculates the optimal focal point for magnifying the specimen 108, and adjusts the lens 106a accordingly. The microprocessor 130 controls a motor 118, which extends and retracts the lens 106a through an adjustment mechanism 136.

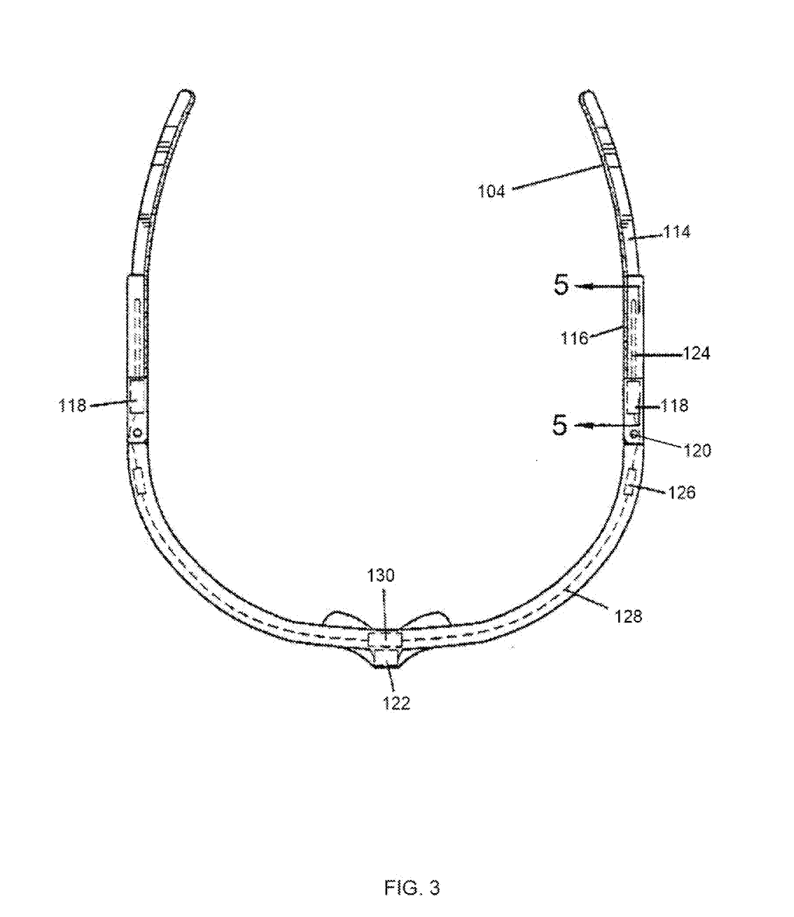

FIG. 3 shows a top view of the microscopic eyewear 100, in accordance with an embodiment of the present invention.

As referenced in FIG. 3, a pair of arms 104 are hingedly connected to the ends of the lens frame 102 through a pivot pin 120. The pair of arms 104 are adapted to be hung on the ears to support the lens frame 102, and thus the lens 106a, in front of the eyes. The pair of arms 104 include an inner surface having a grip member 116 that helps retain the microscopic eyewear 100 on the ears and along the sides of the head.

The pair of arms 104 can pivot laterally to move between an operational position and a storage position. Suitable materials for the pair of arms 104 may include, without limitation, a polymer, polyvinyl chloride, polyurethane, polyethylene, aluminum, fiberglass, rubber, and wood.

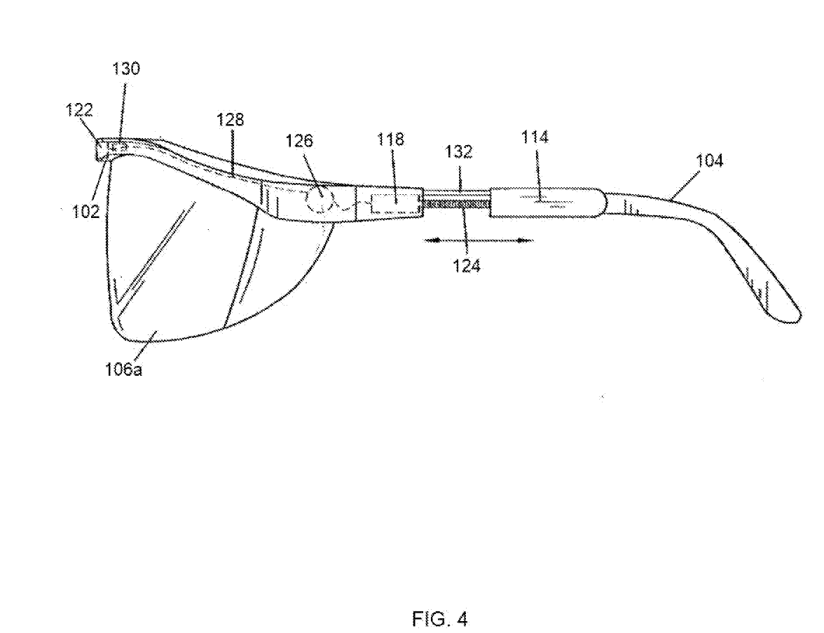

FIG. 4 shows a sectioned side view of the microscopic eyewear 100 showing the circuitry 128, power source 126, and motor 118, in accordance with an embodiment of the present invention.

The pair of arms 104 includes a motor 118 that powers the adjustment mechanism 136 to extend and retract the lens frame 102. This adjustability function helps focus the light 110 and move the lens 106a, 106b in better viewing position to the specimen 108 to form the magnified specimen image 112. A counterweight 114 on each arm 104 helps balance the microscopic eyewear 100 on the ears when the lens frame 102 is fully extended.

The motor 118 may include a DC servo-motor 118 that is housed inside each arm 104. However, in other embodiments, any small electrical motor with position control having sufficient torque to manipulate the lens frame 102 and the lens 106a may be used.

A power source 126 provides power to the motor 118 and the microprocessor 130. The power source 126 may include, without limitation, a battery, a coin battery, a rechargeable battery, and a solar panel. A circuitry 128 comprising wires, resistors, and connectors carries electrical current along the pair of arms 104 between the power source 126 and the motor 118 and microprocessor 130.

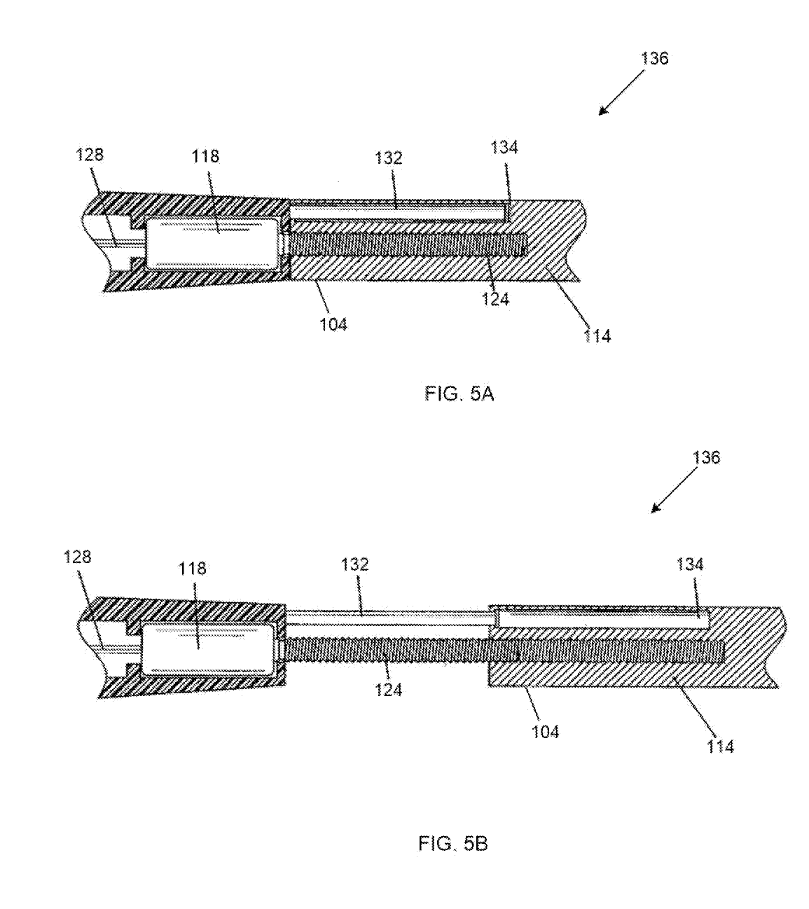

FIGS. 5A and 5B are sectioned side views, the section taken along section 5-5 of FIG. 3, showing an adjustment mechanism 136, where FIG. 5A shows the adjustment mechanism 136 in a retracted position, and FIG. 5B shows the adjustment mechanism 136 in an extended position.

The adjustment mechanism 136 may utilize a worm gear 124 to extend and retract the lens frame 102, and the attached lens 106a. The worm gear 124 includes a threaded rod that meshes with a gear, such that their axis are at 90° from each other during engagement.

The worm gear 124 serves to rotatably increase torque during retraction and extension of the lens frame 102 and the lens 106a. However, in other embodiments, any number of sliding mechanisms may be used to adjust the position of the lens 106a. In any case, the motor 118 works to move the worm gear 124, in response to commands from the microprocessor 130.

The adjustment mechanism 136 further includes a pin 132 that helps align the extension and retraction of the lens frame 102. The pin 132 aligns parallel to the worm gear 124, and slidably moves with the worm gear 124. The pin 132 follows a track 134 that runs along a longitudinal axis of the pair of arms 104. The track 134 helps maintain the pin 132 on a linear path as the lens frame 102 is being adjustably extended and retracted.

Those skilled in the art will recognize that the lens frame 102 extends and retracts in centimeters, and that these adjustments must be sufficiently precise in order to focus the light 110 from the specimen 108 efficiently. Thus, the alignment produced by the pin 132 moving in the track 134 helps create a more detailed and clear magnified specimen image 112.

Turning now to FIG. 5A, the adjustment mechanism 136 fully retracts to a retracted position. In the retracted position, the lens 106a is most proximal to the eyes. However, it is significant to note that the lens 106a can still magnify the specimen 108 from the retracted position. It is also significant to note that since the microscopic eyewear 100 is adorned on the face, further adjustments to focus the light 110 can be performed by moving the head in conjunction with the retraction and extension of the lens 106a.

FIG. 5B shows the adjustment mechanism 136 fully extended in the extended position for extending the lens 106a towards the specimen 108. In one embodiment where one lens 106a is used, the one lens 106a extends with the lens frame 102.

However, in embodiments having multiple lenses 106a, 106b, the lens frame 102 can be bifurcated to extend the objective lens on an outer portion of the lens frame 102, while maintaining the ocular lens stationary and near the eye on an inner portion of the lens frame 102.

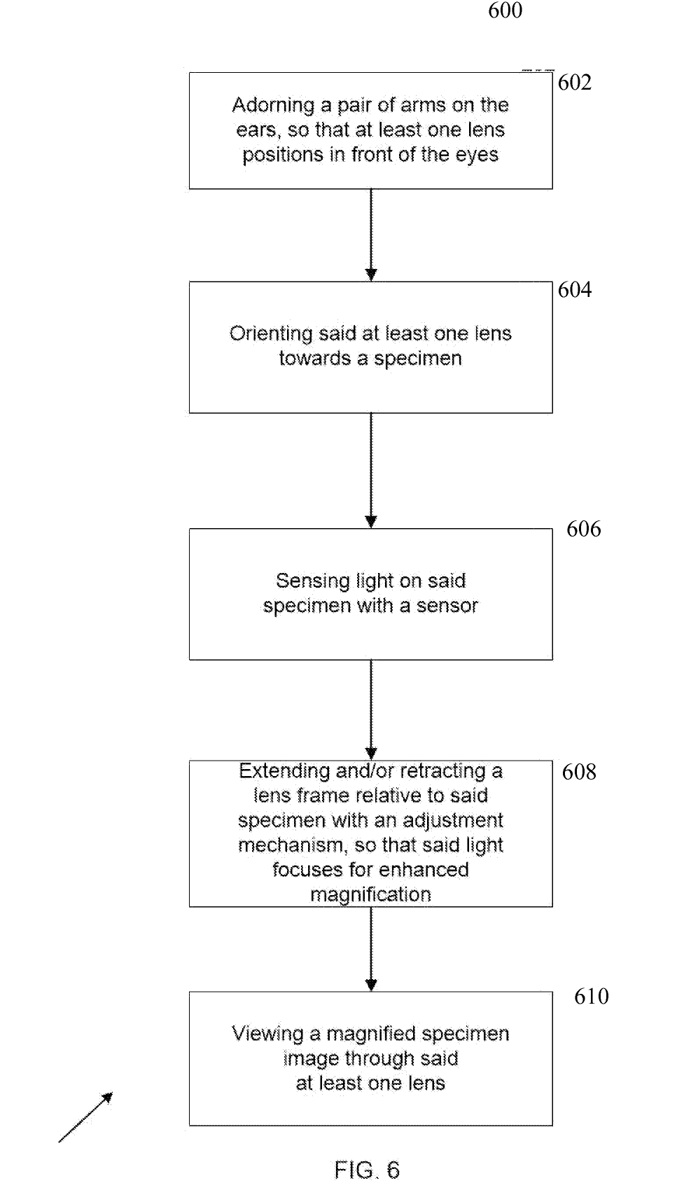

FIG. 6 illustrates a flowchart diagram of an exemplary method 600 for magnifying a specimen with a microscopic eyewear.

The method 600 enables the microscopic eyewear 100 to be worn in front of the eyes to provide portable and hands-free magnification of the specimen 108. The microscopic eyewear 100 utilizes at least one lens 106a, 106b, which generally has a very short focal length, to view the specimen 108 through angular magnification. The lens 106a automatically adjusts its distance relative to the specimen 108, such that light 110 from the specimen 108 is focused to form an enhanced magnified specimen image 112.

The method may include an initial Step 602 of adorning a pair of arms 104 on the ears, so that at least one lens 106a positions in front of the eyes. The pair of arms 104 can be such as those found in a standard pair of eyeglasses. The magnification is made more portable and lightweight by integrating the magnifying capacity in the eyeglasses.

In some embodiments, a Step 604 comprises orienting the at least one lens 106a towards a specimen 108. Since the at least one lens 106a is worn in front of the eyes, like a pair of glasses; the at least one lens 106a can also be positioned laterally, vertically, and horizontally relative to the specimen 108 by simply moving the head to a desired position.

A Step 606 includes sensing light 110 on the specimen 108 with a sensor 122. A sensor 122 on the lens frame 102 senses the light 110 on the specimen 108. In this manner, the specimen 108 is detected and the light 110 that is transmitted through the specimen 108 is focused to create the magnified specimen image 112. A microprocessor 130 in the lens frame 102 operatively connects to the sensor 122 to control the position of the lens 106a.

A Step 608 comprises extending and/or retracting a lens frame 102 relative to the specimen 108 with an adjustment mechanism 136, so that the light 110 focuses for enhanced magnification. To focus at different focal depths, the distance between the lens 106a and the specimen 108 is adjusted. However, to obtain a wider or narrower field of view, multiple lenses 106a, 106b must be used.

The adjustments to the position of the lens 106a focuses the light 110 for capturing the magnified specimen image 112. The adjustment mechanism 136 may utilize a worm gear 124 to extend and retract the lens frame 102, and the attached lens 106a. In any case, the motor 118 works to move the worm gear 124, in response to commands from the microprocessor 130.

A final Step 610 includes viewing a magnified specimen image 112 through the at least one lens 106a. The specimen 108 may include any micro or nano-sized object and can be viewed up to 100× in magnification with the microscopic eyewear 100.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A microscopic eyewear to adjustably magnify a specimen, said microscopic eyewear comprising:
at least one lens configured to magnify a specimen;
a wearable frame disposed to receive with said at least one lens, said wearable frame further having a sensor configured to detect and focus on said specimen;
said wearable frame having at least a pair of temples configured to fit around a user's ears to retain said wearable frame in front of the user's eyes;
said pair of temples hingedly attached to said lens frame, said pair of temples having an adjustment device configured to extend and retract said lens frame relative to said specimen for enhancing said magnification of said specimen, said pair of temples further having a counterweight configured to help balance said microscopic eyewear while extended; and
a processor operatively connected to said sensor, said processor configured to control said adjustment device.

2. The microscopic eyewear of claim 1, wherein said at least one lens comprises a convex lens.

3. The microscopic eyewear of claim 1, wherein said at least one lens comprises an ocular lens proximal to the eyes, and at least one objective lens proximal to said specimen.

4. The microscopic eyewear of claim 1, wherein said ocular lens and said at least one objective lens move relative to each other for enhancing said magnification.

5. The microscopic eyewear of claim 1, wherein said lens frame comprises a slot for receiving a peripheral portion of said at least one lens.

6. The microscopic eyewear of claim 1, wherein said sensor is a photodetector configured to sense light on said specimen.

7. The microscopic eyewear of claim 1, wherein said lens frame comprises a light source configured to transmit light on said specimen.

8. The microscopic eyewear of claim 1, wherein said pair of temples has curved free ends configured to at least partially wrap around the ears.

9. The microscopic eyewear of claim 1, wherein said pair of temples has a grip member configured to enhance stability of said microscopic eyewear.

10. The microscopic eyewear of claim 9, wherein said grip member comprises rubber strip.

11. The microscopic eyewear of claim 1, wherein said pair of temples has lens ends arranged to hingedly join with said lens frame at a pivot pin.

12. The microscopic eyewear of claim 1, wherein said adjustment device has a worm gear.

13. The microscopic eyewear of claim 12, wherein said worm gear is a threaded rod configured to rotatably extend and retract the lens frame.

14. The microscopic eyewear of claim 13, wherein a motor rotates the worm gear.

15. The microscopic eyewear of claim 1, wherein said adjustment device has a pin and a track arranged parallel to the worm gear, said pin configured to extend and retract in said track for helping to align said pair of temples with said lens frame.

16. A method comprising:
providing at least one lens configured to magnify a specimen;
providing a wearable frame disposed to receive with said at least one lens, said wearable frame further having a sensor configured to detect and focus on said specimen;
said wearable frame having at least a pair of temples configured to fit around a user's ears to retain said wearable frame in front of the user's eyes;
said pair of temples hingedly attached to said lens frame, said pair of temples having an adjustment device configured to extend and retract said lens frame relative to said specimen for enhancing said magnification of said specimen, said pair of temples further having a counterweight configured to help balance said microscopic eyewear while extended; and
providing a processor operatively connected to said sensor, said processor configured to control said adjustment device.
